(19) United States
(12) Patent Application Publication
(10) Pub. No.: US 2011/0215216 A1
(43) Pub. Date: Sep. 8, 2011

(54) Enhanced green / eco-friendly coasters and related apparatus/ accoutrements for adding value to the same

(75) Inventor: Vincent Anthony Dimella, Solana Beach, CA (US)

(73) Assignee: Small Axe Corporation, Solana Beach, CA (US)

(21) Appl. No.: 12/462,792

(22) Filed: Aug. 7, 2009

Related U.S. Application Data
(60) Provisional application No. 61/118,545, filed on Nov. 28, 2008.

(51) Int. Cl. A47G 23/03; B23P 11/00

(52) U.S. Cl. 248/346.11; 29/428

(57) ABSTRACT

Improved coaster products feature die-cut apertures of many shapes and Sizes alone or in combination with scalloped or mountain-top emulating upper peripheral surface designs and kits for children to build their own coasters.

### CROSS REFERENCE TO RELATED CASES

The instant filing claims full Paris Convention Priority of Provisional Patent Application filing 61/118,545, Aug. 8, 2008, and expressly incorporates, as if fully set forth herein, each of U.S. letters Pat. No. 6,578,809; Chinese Patent Number 03826577.X; Australian Patent Application Number 2003 228 437; Canadian Patent Application Number 2,524,804; European Patent Application No. 03726189.8 and all applications derived from PCT/US2003/010353 each of which is owned by the instant assignee.

### BACKGROUND OF THE DISCLOSURE

### Field of the Disclosure

The present disclosure relates to coasters and related products used with beverages, beverage holders, containers, and other accessories related to consuming of food and drinks. In particular the present invention eliminates the need for disposable coasters and adds value to coasters by imparting educational value to messages disposed thereupon, and within while providing sustainable products that are green, including eco-friendly products by the disclosed processes, inter alia.

Those who wish to use coasters other than those which require non-sustainable use of consumables or major natural resource destruction to provide them, have ostensive options and alternatives in the marketplace. The MIMPI™ brand of coaster products, produced under U.S. Pat. No. 6,578,809 (inter alia) are available from the NEO-SUPREME® division of the SMALL AXE CORPORATION (Solana Beach, Calif. 92075). Likewise, emulates of this product have been produced by DRESS TO CHILL, of Texas under the LUAU COASTER PANTS® mark, and as product number 08325, manufactured for AMSCAN®, Inc. (Elmsford, N.Y. 10523; Dorval, Que., Canada H9P2T8; Milton Keynes, England MK 10 ODA) as currently available in retail outlets including but not limited to PARTY CITY (nationwide) under the LUAU COASTER BOTTOMS, DON'T SWEAT IT. REST IT moniker. These products each have neoprene features with elastic memory, yet neither of the second and third include objects of the present invention as claimed herein.

Briefly stated, Improved coaster products feature die-cut apertures of many shapes and scalloped or mountain-top emulating designs and kits for children to build their own coasters.

According to embodiments there is disclosed a process for manufacturing a flexible-coaster apparatus, comprising, in combination; Providing at least a strip of side material, and die-cutting or stamping at least one aperture therethrough; Providing a rounded base portion; and joining them together to form an elastically deformable, universally sized cupping member which fits on the bottom of at least conventionally sized bottles, cans and pint glasses.

According to embodiments, there is disclosed Apparatus for bracingly engaging the lower and bottom portion of a vessel for drinking, comprising, in combination, a single strip of elastically deformable material having top and bottom outer surfaces, which surfaces have at least an aperture disposed therebetween; and an attached base portion forming a cup-like member when attached to the single strip of elastically deformable material having top and bottom outer surfaces, which surfaces have at least an aperture disposed therebetween.

According to embodiments, there a kit, comprising at least two flexible neoprene coasters, and cutting/stamping tools, marking pens, gemstones, baubles and glue, along with instructions for use to enable children to create their own die cut, art patterns and customized décor.

### BRIEF DESCRIPTION OF THE DRAWINGS

FIG. 1 is a schematic of the teachings of the present invention, showing the same as used with a conventional drinking vessel and alone; and

FIG. 2 likewise shows a view of the outer side wall of embodiments the teachings of the present invention, including stars, sun, scalloped and mountain-top versions which are illustrative and not limiting.

### DETAILED DESCRIPTION OF THE INVENTION

The present inventor has discovered that flexible neoprene coaster products have both promotional and retail usages that have provided consumers with myriad benefits, (see U.S. Letters Pat. No. 6,578,809, inter alia). In addition to those benefits with respect to colors, color stories and logos or themes, using die-cutting (for example) to create apertures/make holes has enhanced the appearance of the resultory products.

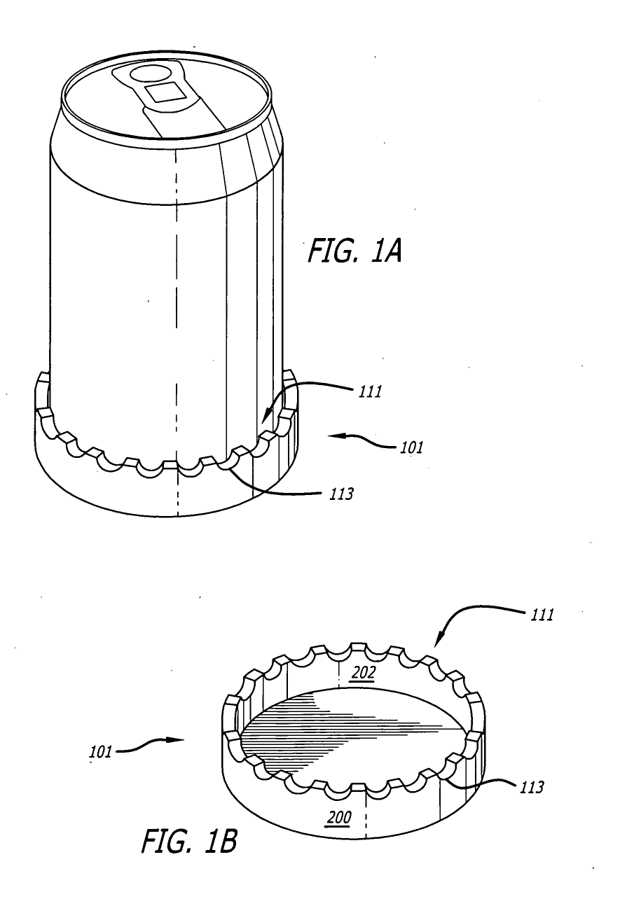

Referring now to FIG. 1, flexible coaster apparatus 101 includes a multiplicity of crests 111, and valleys 113, disposed at a top side of a peripheral edge of flexible coaster apparatus 101.

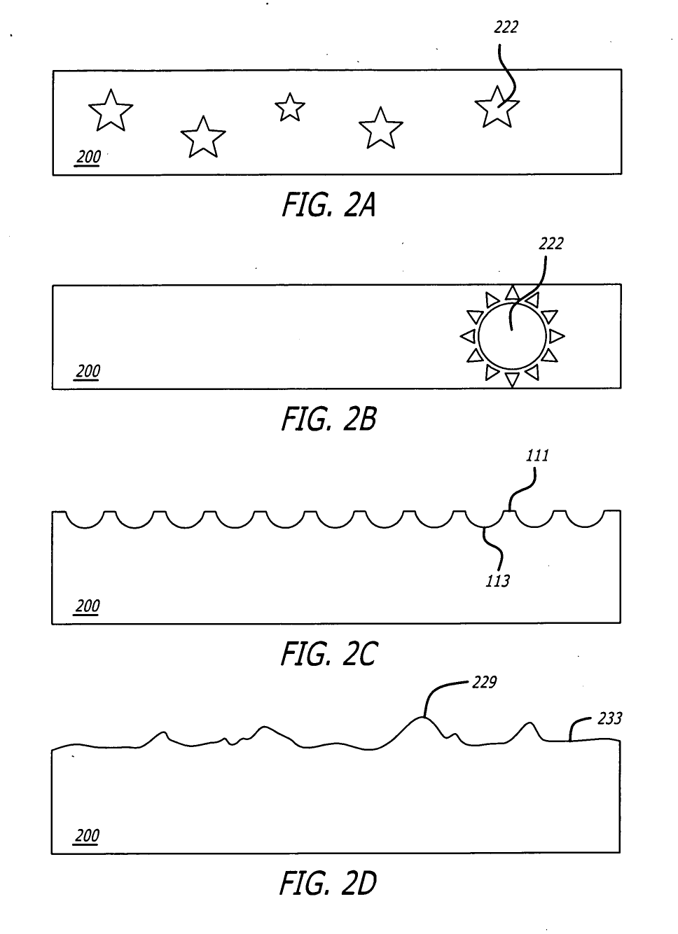

Referring now also to FIG. 2, aperture(s) 222 may be die-cut stamped, pressed or otherwise extend through outer side wall portion 200 and through inner sidewall portion 202. Shapes and inner tapers of the cut-out(s) can be used to create different shapes, for example, soccer balls (illustrated by icosahedral triangular sections subdividing space filling or opening hexagonal and pentagonal apertures).

Likewise, stars, suns and numerous other shapes work for aperture(s) 222 as show in FIG. 2, alone or in combination with other graphic depictions of the outline of mountains 229 and valleys 233 or the tops of crowns 111, and concavities of such scalloped shapes. See www.smallaxecorp.com for further examples.

While the formulations and methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

While the methods and agents have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even, if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A process for manufacturing a flexible-coaster apparatus, comprising, in combination:
Providing at least a strip of side material, and die-cutting or stamping at least one aperture therethrough;
Providing a rounded base portion; and
Joining them together to form an elastically deformable, universally sized cupping member which fits on the bottom of at least conventionally sized bottles, cans and pint glasses.

2. The process of claim 1, wherein said aperture is in the shape of a star.

3. The process of claim 1, wherein said at least one aperture comprises a plurality of apertures in the shape of a soccer ball, illustrated by icosahedral triangular sections subdividing space filling or opening hexagonal and pentagonal apertures.

4. The process of claim 1, wherein the at least a strip of side material is pre-cut forming at least one aperture.

5. The process of claim 1, wherein said aperture is lined with a metal fitting which is matingly engaged therein.

6. The process of claim 1, said at least a strip of side material being scalloped along a top peripheral edge, whereby the resultory cupping member has a ‘crown-like’ appearance.

7. The process of claim 1, said at least a strip of side material being carved-out in the shape of at least one of a mountain range and a skyline along the peripheral edge, whereby the resultory cupping member has an appearance like the top profile of at least one of a skyline and a range of mountains.

8. Apparatus for bracingly engaging the lower and bottom portion of a vessel for drinking, comprising, in combination:
A single strip of elastically deformable material having top and bottom outer surfaces, which surfaces have at least an aperture disposed therebetween; and
an attached base portion forming a cup-like member when attached to the single strip of elastically deformable material having top and bottom outer surfaces, which surfaces have at least an aperture disposed therebetween.

9. Apparatus of claim 8, said at least an aperture being a plurality of apertures.

10. Apparatus of claim 9, said plurality of apertures further comprising stars.

11. Apparatus of claim 9, said plurality of apertures further comprising the shape of a soccer ball, illustrated by icosahedral triangular sections subdividing space filling or opening hexagonal and pentagonal apertures.

12. Apparatus of claim 8, said at least an aperture being filled in, and said at least a strip of side material being at least one of scalloped along a top peripheral edge, whereby the resultory cupping member has a ‘crown-like’ appearance, and
carved-out in the shape of at least one of a mountain range and a skyline along the peripheral edge, whereby the resultory cupping member has an appearance like the top profile of at least one of a skyline and a range of mountains.

13. A kit, comprising at least two flexible neoprene coasters, and cutting/stamping tools, marking pens, gemstones, baubles and glue, along with instructions for use to enable children to create their own die cut, art patterns and customized décor.
